(19) United States
(12) Patent Application Publication
(10) Pub. No.: US 2019/0266564 A1
(43) Pub. Date: Aug. 29, 2019

(54) Control Device, Non-Transitory Computer-Readable Recording Medium Storing Computer-Readable Instructions For Control Device, and Method

(71) Applicant: Brother Kogyo Kabushiki Kaisha, Nagoya-shi (JP)

(72) Inventor: Hirokazu Banno, Nagoya-shi (JP)

(21) Appl. No.: 16/279,195

(22) Filed: Feb. 19, 2019

(30) Foreign Application Priority Data
Feb. 23, 2018 (JP) 2018-031222

(51) Int. Cl. G06Q 10/08

(52) U.S. Cl. CPC G06Q 10/0838

(57) ABSTRACT

A control device may execute a shipping process; every time the shipping process is executed, store in a memory an association of device identification information and a code assigned to the consumable article; and in a case where a specific code is received from a first device after an association of first device identification information and a first code has been stored in the memory due to execution of a first shipping process and after the specific consumable article has been newly attached to the first device, determine whether the specific code is identical to the first code, wherein in a case where it is determined that the specific code is identical to the first code, a second shipping process may be executed, and in a case where it is determined that the specific code is not identical to the first code, the second shipping process may not be executed.

### CROSS-REFERENCE

This application claims priority to Japanese Patent Application No. 2018-031222, filed on Feb. 23, 2018, the entire contents of which are incorporated herein by reference.

### TECHNICAL FIELD

The disclosure herein discloses a technology related to a control device configured to execute a shipping process for shipping a consumable article to be attached to a device.

### BACKGROUND ART

A system including an MFP (an abbreviation of a Multi-Function Peripheral) and a server is known. The server receives, from the MFP, remaining amount information of a toner container attached to the MFP, and executes a process for shipping a toner container in accordance with the remaining amount information. The server stores toner container identification information for identifying a toner container that was already shipped. When a user changes toner containers, the MFP sends, to the server, toner container identification information of a newly attached toner container. In a case of receiving the toner container identification information from the MFP, the server determines whether the toner container identification information is already stored. In a case of determining that the toner container identification information is already stored, the server stores information related to the toner container change. On the other hand, in a case of determining that the toner container identification information is not stored yet, the server informs the user that a toner container that is not shipped by the server is attached to the MFP.

### SUMMARY

For example, a situation is assumed in which before a first toner container shipped by a server is delivered to a user of an MFP, the user buys a second toner container at a store and attaches the second toner container to the MFP. In this case, the user comes to own the unused first toner container with the second toner container attached to the MFP. According to the aforementioned technology, when the server receives remaining amount information of the second toner container from the MFP in such a situation, the server may ship a third toner container to the user. In other words, the third toner container is shipped to the user even though the user owns the unused first toner container.

The disclosure herein discloses a technology for suppressing an excess consumable article from being owned by a user.

A control device disclosed herein may comprise a processor; and a memory storing computer-readable instructions therein, the computer-readable instructions, when executed by the processor, causing the control device to: execute a shipping process for shipping a consumable article to be attached to a device; every time the shipping process for shipping a consumable article to be attached to a device is executed, store in a memory an association of device identification information for identifying the device and a code assigned to the consumable article; and in a case where a specific code assigned to a specific consumable article is received from a first device after an association of first device identification information for identifying the first device and a first code assigned to a first consumable article has been stored in the memory due to execution of a first shipping process which is the shipping process for shipping the first consumable article to be attached to the first device and after the specific consumable article has been newly attached to the first device, determine whether the specific code is identical to the first code associated with the first device identification information in the memory, wherein in a case where it is determined that the specific code is identical to the first code, a second shipping process which is the shipping process for shipping a second consumable article to be attached to the first device may be executed, and in a case where it is determined that the specific code is not identical to the first code, the second shipping process may not be executed.

Computer-readable instructions for implementing the above control device, and a non-transitory computer-readable recording medium storing the computer-readable instructions are also novel and useful. Further, a method performed by the above control device is also novel and useful. In addition, a communication system comprising the above control device and another device (e.g., the first device) is also novel and useful.

### BRIEF DESCRIPTION OF THE DRAWINGS

FIG. 1 shows a configuration of a communication system.

FIG. 2 shows examples of respective tables.

FIG. 3 shows a sequence diagram of a process of registering information for a shipping process.

FIG. 4 shows a diagram for describing a situation 1 in an embodiment.

FIG. 5 shows a diagram for describing a situation 2 in the embodiment.

FIG. 6 shows a diagram for describing a situation 3 in the embodiment.

FIG. 7 shows a diagram for describing a situation 4 in the embodiment.

FIG. 8 shows a diagram for describing a situation 5 in the embodiment.

FIG. 9 shows a flowchart of a process executed by a management server.

FIG. 10 shows a flowchart of an identical process.

FIG. 11 shows a flowchart of a non-identical process.

FIG. 12 shows a flowchart of a changing process.

### EMBODIMENT

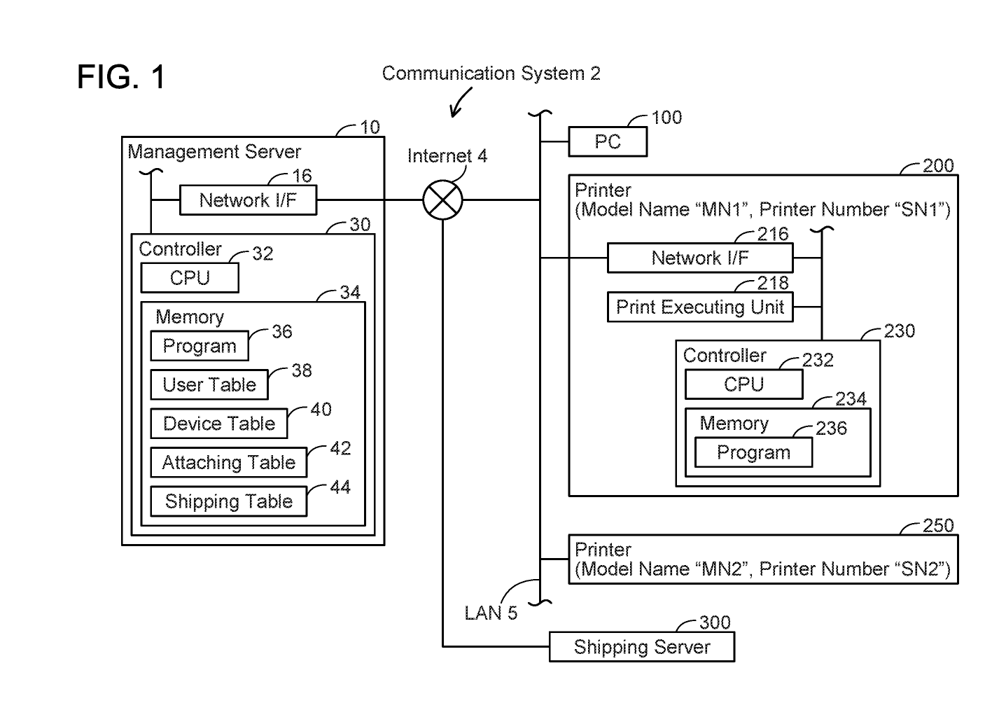

(Configuration of Communication System 2: FIG. 1)

As shown in FIG. 1, a communication system 2 includes a management server 10, a PC (an abbreviation of a Personal Computer) 100, a plurality of printers 200, 250, and a shipping server 300 configured to ship a consumable article (e.g., an ink cartridge) to be attached to each of the printers. The PC 100 and each of the printers 200, 250 are connected to a LAN (an abbreviation of a Local Area Network) 5. The LAN 5 is connected to the Internet 4. The management server 10 and the shipping server 300 are provided on the Internet 4. The devices 10, 100, 200, 250, and 300 thus can communicate with each other via the Internet 4. The PC 100 is a stationary PC. In a variant, the PC 100 may be a portable terminal device such as a mobile phone (e.g., a smartphone), a PDA, a laptop PC, or a tablet PC.

(Configuration of Management Server 10)

The management server 10 is a server configured to manage information on each of the printers 200, 250, and instruct the shipping server 300 to ship a consumable article that is a cartridge accommodating printing material. The management server 10 is provided by a vendor of each of the printers 200, 250. In a variant, the management server 10 may be provided by a business operator different from the vendor of each of the printers 200, 250. The management server 10 includes a network interface 16 and a controller 30. Each of the units 16, 30 is connected to a bus line (of which reference sign is omitted). An interface will hereinafter be denoted as an “I/F”. The network OF 16 is connected to the Internet 4.

The controller 30 includes a CPU 32 and a memory 34. The CPU 32 executes various processes in accordance with a program 36 stored in the memory 34. The memory 34 is constituted of a volatile memory, a nonvolatile memory, and the like. The memory 34 stores a user table 38, a device table 40, an attaching table 42, and a shipping table 44.

(Configuration of Each of Printers 200, 250)

Each of the printers 200, 250 is a peripheral device (e.g., a peripheral device of the PC 100) that can execute a printing function. The printer 200 has a model name MN1 and a printer number SN1. The printer 250 has a model name MN2 and a printer number SN2. The printers 200, 250 have different model names, but can execute printing by using consumable articles that have a same model number. In the present embodiment, a situation is assumed in which the printers 200, 250 are owned by a same user. The printers 200, 250 include similar configurations. Therefore, only a configuration of the printer 200 will hereinafter be described, while the description for the configuration of the printer 250 will be omitted.

The printer 200 includes a network I/F 216, a print executing unit 218, and a controller 230. Each of the units 216 to 230 is connected to a bus line (of which reference sign is omitted). The network I/F 216 is connected to the LAN 5. The print executing unit 218 includes an attachment portion to which a consumable article is attached and a printing mechanism that executes printing by using the consumable article. The printing mechanism may be either of an inkjet printing mechanism or a laser printing mechanism.

The controller 230 includes a CPU 232 and a memory 234. The CPU 232 executes various processes in accordance with a program 236 stored in the memory 234. The memory 234 is constituted of a volatile memory, a nonvolatile memory, and the like.

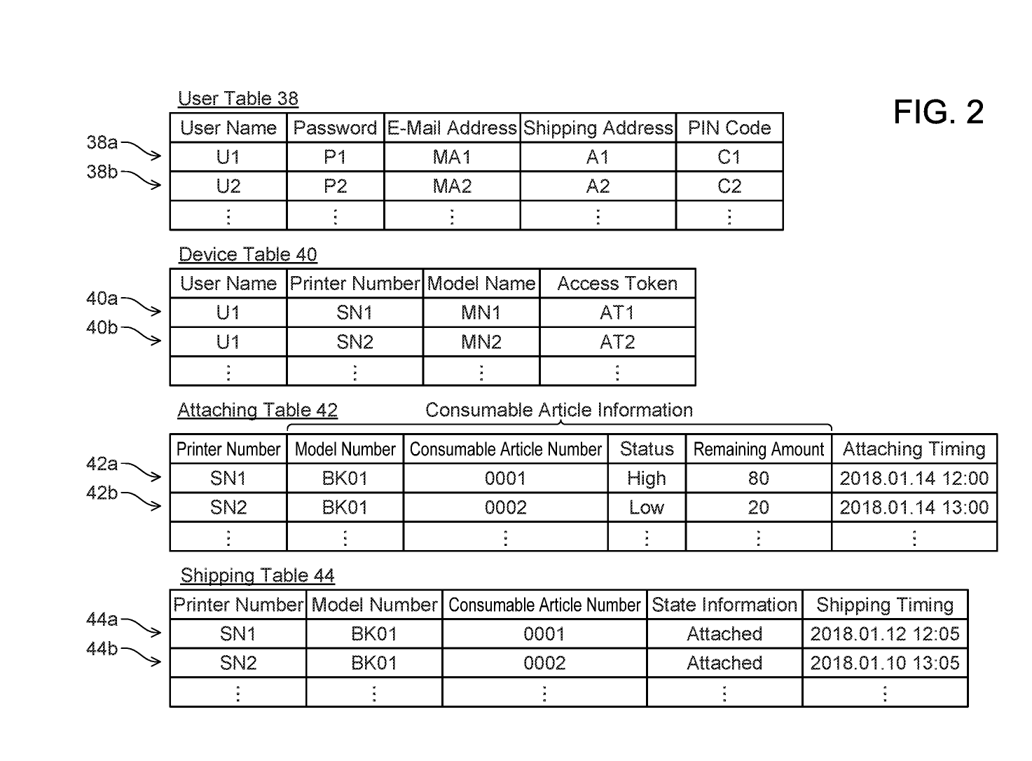

(Tables 38, 40, 42, 44: FIG. 2)

Next, with reference to FIG. 2, each of the tables 38, 40, 42, 44 stored in the memory 34 in the management server 10 will be described. The user table 38 is a table for managing users of printers. The user table 38 includes user information 38a and user information 38b. In each user information, a user name, a password, an e-mail address, a shipping address, and a PIN code are associated with one another. Each of the user name and the password is information for logging in to the management server 10. The e-mail address is an e-mail address assigned to a user. The shipping address indicates a shipping address for a consumable article. The PIN code is information used when information on a printer is registered in the management server 10.

The device table 40 is a table for managing printers. The device table 40 includes device information 40a and device information 40b. In each device information, a user name, a printer number, a model name, and an access token are associated with one another. The access token is information for executing communication between a printer and the management server 10.

The attaching table 42 is a table for managing consumable articles attached to printers. The attaching table 42 includes attaching information 42a and attaching information 42b. In each attaching information, a printer number, consumable article information, and an attaching timing are associated with one another. The consumable article information includes a model number of a consumable article, a consumable article number assigned to the consumable article, a status that indicates a remaining amount of the consumable article, and the remaining amount itself of the consumable article. The status is set to one of “High” indicating that the remaining amount of the consumable article is equal to or greater than a preset threshold value and “Low” indicating that the remaining amount of the consumable article is less than the threshold value. The remaining amount is information that indicates an amount of ink remaining in an ink cartridge in percentage. The attaching timing is timing information related to date and time when a consumable article was attached to a printer.

The shipping table 44 is a table for managing shipped consumable articles. The shipping table 44 includes shipping information 44a and shipping information 44b. In each shipping information, a printer number, a model number of a consumable article, a consumable article number, state information, and a shipping timing are associated with one another. The state information is information that indicates a state of a shipped consumable article, and is set to one of “Shipped” indicating that a shipping process for a consumable article was executed and “Attached” indicating that a shipped consumable article was attached to a printer. The shipping timing is timing information related to date and time when a shipping process was executed.

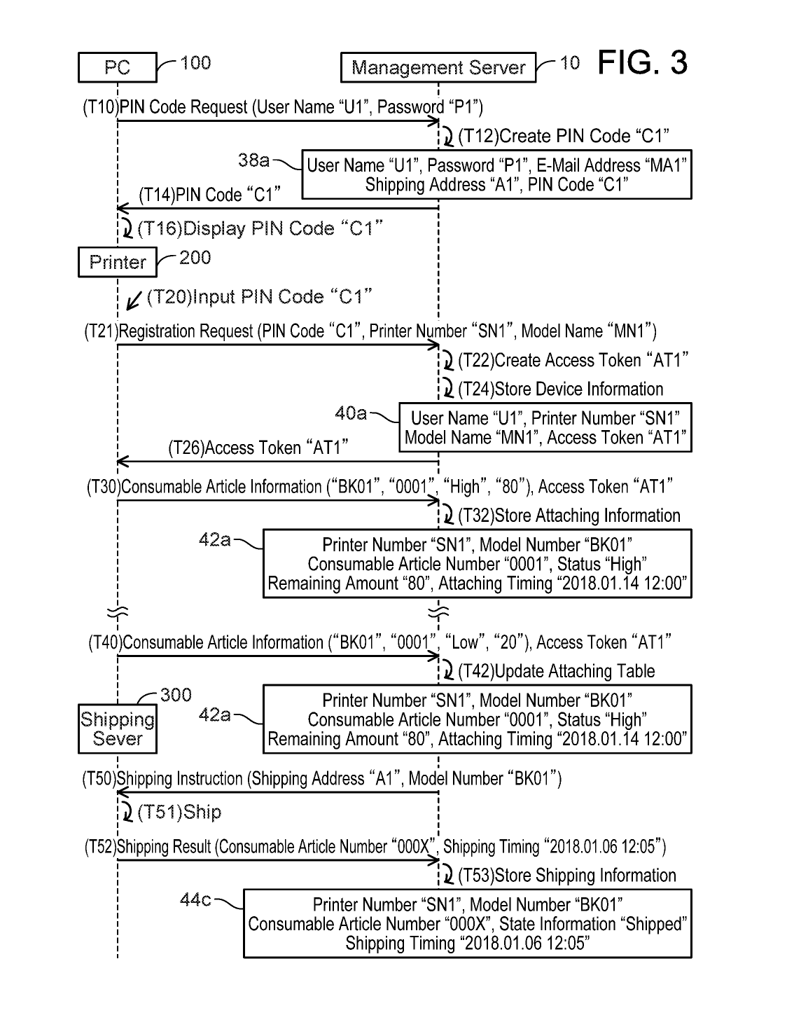

(Process for Shipping Consumable Article: FIG. 3)

Next, with reference to FIG. 3, a process of registering information for a shipping process in the above communication system 2 will be described. In the process of FIG. 3, the device information 40a and the attaching information 42a of the printer 200 (see FIG. 2) are registered in the device table 40 and the attaching table 42. For easy understanding, processes executed by the CPUs (e.g., the CPU 32) of the devices will hereinafter be described with the devices (e.g., the management server 10) as subjects of action, not describing with the CPUs as the subjects of action. Moreover, the devices (e.g., the management server 10) execute communications described below via their network I/Fs (e.g., 16). Therefore, the description “via a network I/F (e.g., 16)” will hereinafter be omitted.

As preparation, a user of the printer 200 registers, in advance, a user name U1, a password P1, an e-mail address MA1, and a shipping address A1 in the user table 38 in the management server 10 by using, for example, the PC 100. In other words, in an initial state of FIG. 3, the user table 38 already stores the user information 38a (see FIG. 2) including the user name U1, the password P1, the e-mail address MA1, and the shipping address A1. However, the user information 38a does not include a PIN code yet at this time.

In response to accepting, from the user, a registration operation for registering the printer in the management server 10, the PC 100 sends to the management server 10 a PIN code request for requesting sending of a PIN code in T10. The PIN code request includes the user name U1 and the password P1.

In a case of receiving the PIN code request from the PC 100 in T10, the management server 10 determines whether the user name U1 and the password P1 in the PIN code request are stored in the user table 38. In a case of determining that the user name U1 and the password P1 are stored in the user table 38, namely, in a case of specifying the user information 38a including the user name U1 and the password P1 from the user table 38, the management server 10 creates a PIN code C1 and further stores the PIN code C1 in the specified user information 38a in T12. In T14, the management server 10 then sends the PIN code C1 to the PC 100.

In response to receiving the PIN code C1 from the management server 10 in T14, the PC 100 displays the PIN code C1 in T16. The user can thereby know the PIN code C1.

Subsequently, in response to accepting an input of the PIN code C1 from the user in T20, the printer 200 sends to the management server 10 a registration request including the PIN code C1, the printer number SN1, and the model name MN1 in T21.

In response to receiving the registration request from the printer 200 in T21, the management server 10 determines whether the PIN code C1 in the registration request is stored in the user table 38. In a case of determining that the PIN code C1 is stored in the user table 38, namely, in a case where the PIN code C1 is successfully authenticated, the management server 10 creates an access token AT1 in T22. The management server 10 then specifies the user name U1 associated with the PIN code C1 from the user table 38, and stores the device information 40a (see FIG. 2) in the device table 40 in T24. The device information 40a includes the specified user name U1, the printer number SN1 in the registration request, the model name MN1 in the registration request, and the created access token AT1. The management server 10 then sends the access token AT1 to the printer 200 in T26.

In response to receiving the access token AT1 from the management server 10 in T26, the printer 200 sends consumable article information of a consumable article currently attached to the printer 200 and the access token AT1 to the management server 10 in T30. This consumable article information includes a model number “BK01”, a consumable article number “0001”, a status “High”, and a remaining amount “80”.

In response to receiving the consumable article information and the access token AT1 from the printer 200 in T30, the management server 10 specifies the printer number SN1 associated with the access token AT1 from the device table 40, and stores the attaching information 42a (see FIG. 2) in the attaching table 42 in T32. The attaching information 42a includes the specified printer number SN1, the received consumable article information (i.e., the model number “BK01”, the consumable article number “0001”, the status “High”, and the remaining amount “80”), and an attaching timing “2018.01.14 12:00” that is a current timing. In other words, the attaching timing is timing information related to date and time when the consumable article information was received from the printer 200 in T30.

Moreover, in response to receiving the access token AT1 from the management server 10 in T26, the printer 200 starts periodically sending the consumable article information to the management server 10. Here, a situation is assumed in which a printing process is executed in the printer 200 after execution of the process of T32, and the remaining amount of the consumable article attached to the printer 200 decreases. In this case, in a case where a predetermined time elapses after the execution of the process of T32, the printer 200 sends the consumable article information and the access token AT1 to the management server 10 in T40. This consumable article information includes the model number “BK01”, the consumable article number “0001”, the status “Low”, and the remaining amount “20”.

In a case of receiving the consumable article information and the access token AT1 from the printer 200 in T40, the management server 10 updates the attaching table 42 in T42. Specifically, the management server 10 specifies the printer number SN1 associated with the access token AT1 from the device table 40, and specifies the attaching information 42a (see T32) including the specified printer number SN1 from the attaching table 42. The management server 10 then stores the status “Low” and the remaining amount “20” included in the received consumable article information in the attaching information 42a, in place of the status “High” and the remaining amount “80” in the attaching information 42a.

Moreover, since the status in the consumable article information is “Low”, in other words, since the remaining amount of the consumable article currently attached to the printer 200 is less than the threshold value, the management server 10 executes a shipping process for the printer 200. Specifically, the management server 10 firstly specifies, from the device table 40, the user name U1 associated with the printer number SN1 specified in T42, and specifies, from the user table 38, the shipping address A1 associated with the specified user name U1. In T50, the management server 10 then sends to the shipping server 300 a shipping instruction for causing the shipping server 300 to ship a consumable article. This shipping instruction includes the specified shipping address A1 and the model number “BK01” in the consumable article information in T40.

In response to receiving the shipping instruction from the management server 10 in T50, the shipping server 300 ships, in T51, a consumable article having the model number “BK01” in the shipping instruction to the shipping address A1 in the shipping instruction, and sends to the management server 10, in T52, a shipping result including a consumable article number “000X” assigned to the shipped consumable article and a shipping timing “2018.01.16 12:05” that is a current timing. In other words, the shipping timing is timing information related to date and time when the shipping process was executed in T51.

In response to receiving the shipping result from the shipping server 300 in T52, the management server 10 stores shipping information 44c in the shipping table 44 in T53. The shipping information 44c includes the printer number SN1 specified in T42, the model number “BK01” in the consumable article information of T40, the consumable article number “000X” in the shipping result, the predetermined state information “Shipped”, and the shipping timing “2018.01.16 12:05” in the shipping result.

Since a new consumable article having the model number “BK01” and the consumable article number “000X” is shipped to the user due to the execution of the process of FIG. 3, the user can attach the new consumable article to the printer 200 when the consumable article currently attached to the printer 200 is exhausted.

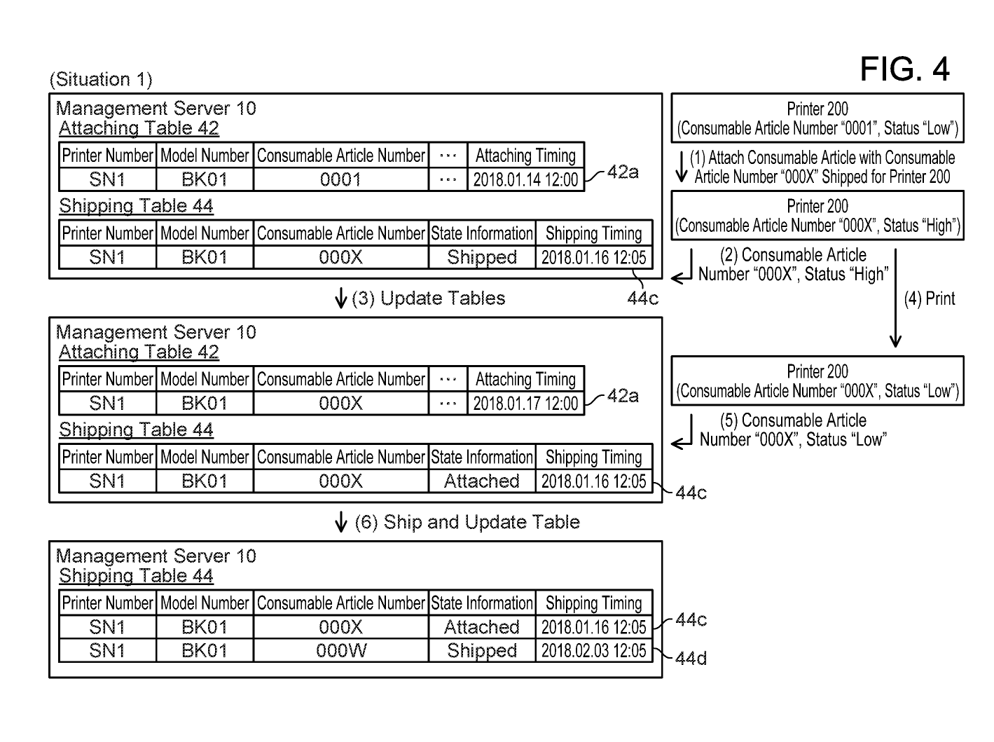

(Situation 1: FIG. 4)

Next, with reference to FIGS. 4 to 8, situations 1 to 5 assumed in the communication system 2 will be described. Firstly, with reference to FIG. 4, the situation 1 in which a consumable article shipped for the printer 200 is attached to the printer 200 will be described. The situation 1 is a situation after the consumable article having the consumable article number “000X” has been shipped to the user due to the execution of the process of FIG. 3.

(1) The consumable article having the consumable article number “0001” is currently attached to the printer 200. Therefore, the attaching table 42 in the management server 10 stores the attaching information 42a including the consumable article number “0001”. Moreover, the shipping table 44 in the management server 10 stores the shipping information 44c (see T53 in FIG. 3) including the consumable article number “000X”. In the printer 200, when the consumable article having the consumable article number “0001” is exhausted, the shipped consumable article (i.e., the consumable article having the consumable article number “000X”) is attached in place of the consumable article having the consumable article number “0001”.

(2) Subsequently, in response to a predetermined time having elapsed, the printer 200 sends consumable article information including the consumable article number “000X” and the status “High” to the management server 10.

(3) In response to receiving the consumable article information from the printer 200, the management server 10 updates the attaching table 42 and the shipping table 44. Specifically, the management server 10 stores the consumable article number “000X” included in the consumable article information in place of the consumable article number “0001”, and updates the attaching timing to a current timing “2018.01.17 12:00”, in the attaching information 42a in the attaching table 42. Moreover, the management server 10 specifies, from the shipping table 44, the shipping information 44c including the consumable article number “000X” in the consumable article information, and changes the state information in the shipping information 44c from “Shipped” to “Attached”.

(4) Subsequently, due to execution of a printing process in the printer 200, the remaining amount of the consumable article attached to the printer 200 decreases, and the status thereof is changed from “High” to “Low”.

(5) In response to a predetermined time having elapsed, the printer 200 sends consumable article information including the consumable article number “000X” and the status “Low” to the management server 10.

(6) In response to receiving the consumable article information from the printer 200, the management server 10 executes the shipping process for the printer 200 because the status in the consumable article information is “Low”. Consequently, the shipping server 300 ships a consumable article having a consumable article number “000W”. The management server 10 then newly stores, in the shipping table 44, shipping information 44d including the consumable article number “000W”. Due to this, when the consumable article having the consumable article number “000X” is exhausted, the user can attach the shipped consumable article having the consumable article number “000W” to the printer 200.

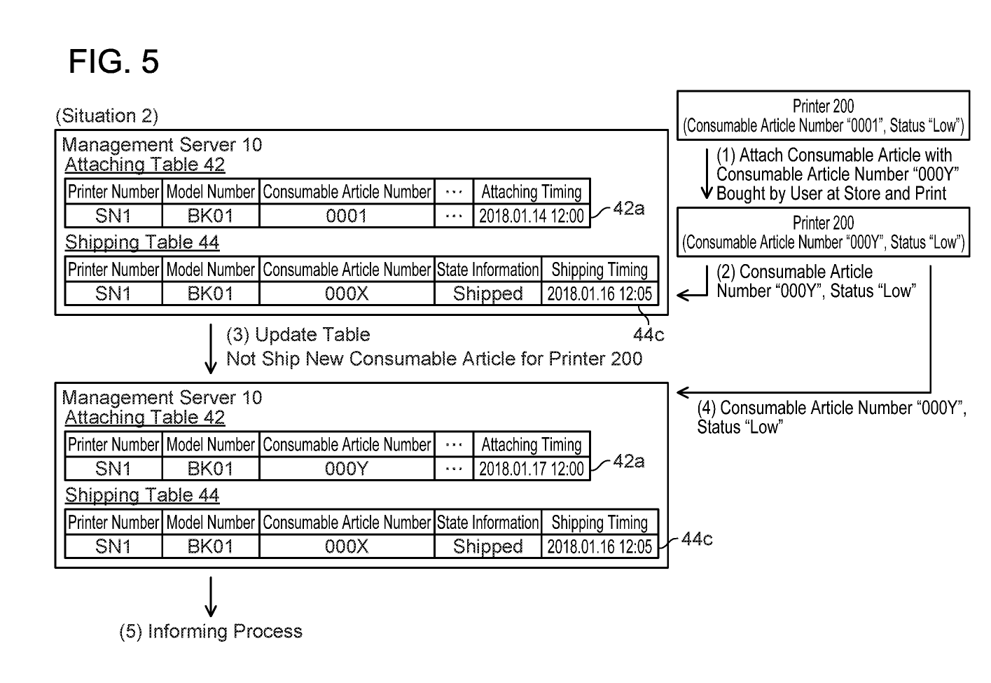

(Situation 2: FIG. 5)

Next, with reference to FIG. 5, the situation 2 in which a consumable article shipped for the printer 200 is not attached to the printer 200 will be described. As in the situation 1 in FIG. 4, the situation 2 is also a situation after the consumable article having the consumable article number “000X” has been shipped to the user due to the execution of the process of FIG. 3. The tables 42, 44 in the management server 10 thus store the attaching information 42a and the shipping information 44c, which are similar to those in the situation 1 in FIG. 4.

(1) When the consumable article in the printer 200 is exhausted after the consumable article having the consumable article number “000X” has been shipped and before it is delivered to the user, the user buys a consumable article having a consumable article number “000Y” at a store. The consumable article having the consumable article number “000Y” is then attached to the printer 200 in place of the consumable article having the consumable article number “0001”. Subsequently, the status is changed to “Low” due to the execution of printing process in the printer 200.

(2) In response to a predetermined time having elapsed, the printer 200 sends consumable article information including the consumable article number “000Y” and the status “Low” to the management server 10.

(3) In response to receiving the consumable article information from the printer 200, the management server 10 updates the attaching table 42. Specifically, the management server 10 stores the consumable article number “000Y” included in the consumable article information in place of the consumable article number “0001”, and updates the attaching timing to a current timing “2018.01.17 12:00”, in the attaching information 42a in the attaching table 42. Moreover, since the shipping table 44 does not store shipping information including the consumable article number “000Y” included in the consumable article information, the management server 10 determines that the consumable article currently attached to the printer 200 is not the shipped consumable article. In this case, there is a high possibility that the user does not yet use the consumable article having the consumable article number “000X”, so the management server 10 does not execute the shipping process for the printer 200 even though the status in the consumable article information is “Low”. This can suppress a consumable article from being newly shipped to the user even though the user owns the unused consumable article. Thus, this can suppress excess consumable articles from being owned by the user.

(4) Subsequently, in response to a predetermined time having elapsed, the printer 200 sends again the consumable article information including the consumable article number “000Y” and the status “Low” to the management server 10.

(5) In response to receiving the consumable article information from the printer 200, the management server 10 determines that the user owns the unused consumable article (i.e., the consumable article having the consumable article number “000X”) because the shipping information 44c including the state information “Shipped” exists in the shipping table 44. In this case, the management server 10 executes an informing process of informing the user that the shipped consumable article is to be attached to the printer 200, and does not execute the shipping process for the printer 200.

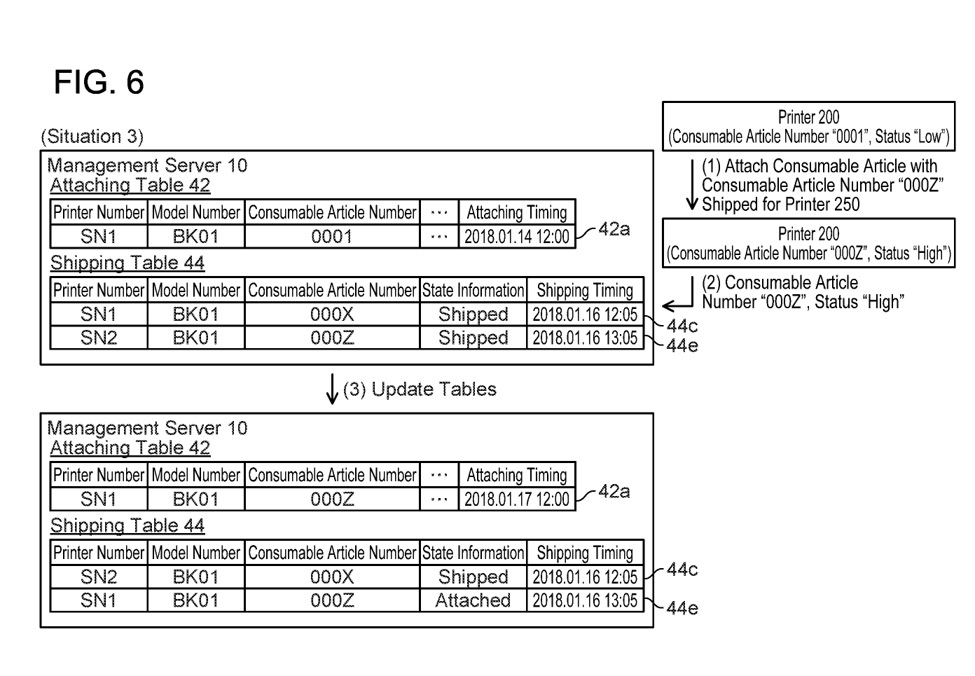

(Situation 3: FIG. 6)

Next, with reference to FIG. 6, the situation 3 in which a consumable article shipped for the printer 250 is attached to the printer 200 will be described. The situation 3 is a situation after the following event: after the consumable article having the consumable article number “000X” has been shipped to the user due to the execution of the process of FIG. 3, a similar process to that of FIG. 3 is further executed by using the printer 250, as a result of which a consumable article having a consumable article number “000Z” has been shipped to the user. In other words, the consumable article having the consumable article number “000X” has been shipped for the printer 200 having the printer number SN1, and the consumable article having the consumable article number “000Z” has been shipped for the printer 250 having the printer number SN2. Therefore, the attaching table 42 in the management server 10 stores the attaching information 42a similar to that in the situation 1 in FIG. 4, and the shipping table 44 stores the shipping information 44c including the printer number SN1 and the consumable article number “000X” and shipping information 44e including the printer number SN2 and the consumable article number “000Z”.

(1) The printers 200, 250 are owned by the same user. Therefore, the user owns both of the consumable article having the consumable article number “000X” shipped for the printer 200 and the consumable article having the consumable article number “000Z” shipped for the printer 250. When the consumable article having the consumable article number “0001” is exhausted in the printer 200, the user is supposed to attach the consumable article having the consumable article number “000X” to the printer 200 in place of the consumable article having the consumable article number “0001”. However, the user erroneously attaches the consumable article having the consumable article number “000Z” to the printer 200.

(2) Subsequently, in response to a predetermined time having elapsed, the printer 200 sends consumable article information including the consumable article number “000Z” and the status “High” to the management server 10.

(3) In response to receiving the consumable article information from the printer 200, the management server 10 updates the attaching table 42 and the shipping table 44. Specifically, the management server 10 stores the consumable article number “000Z” included in the consumable article information in place of the consumable article number “0001”, and updates the attaching timing to a current timing “2018.01.17 12:00”, in the attaching information 42a in the attaching table 42. Moreover, the management server 10 switches the printer number SN1 in the shipping information 44c and the printer number SN2 in the shipping information 44e in the shipping table 44. Due to this, the printer number SN2 and the consumable article number “000X” are associated with each other in the shipping information 44c, and the printer number SN1 and the consumable article number “000Z” are associated with each other in the shipping information 44e. The management server 10 then changes the state information in the shipping information 44e from “Shipped” to “Attached”.

In the situation 3, after the execution of the processes (1) to (3) above, the consumable article having the consumable article number “000X” may be attached to the printer 250. If this happens, the management server 10 receives consumable article information including the printer number SN2 and the consumable article number “000X” from the printer 250. In this case, since the management server 10 stores the shipping information 44c in which the printer number SN2 and the consumable article number “000X” are associated with each other (see (3) above), the management server 10 can change the state information in the shipping information 44c from “Shipped” to “Attached”.

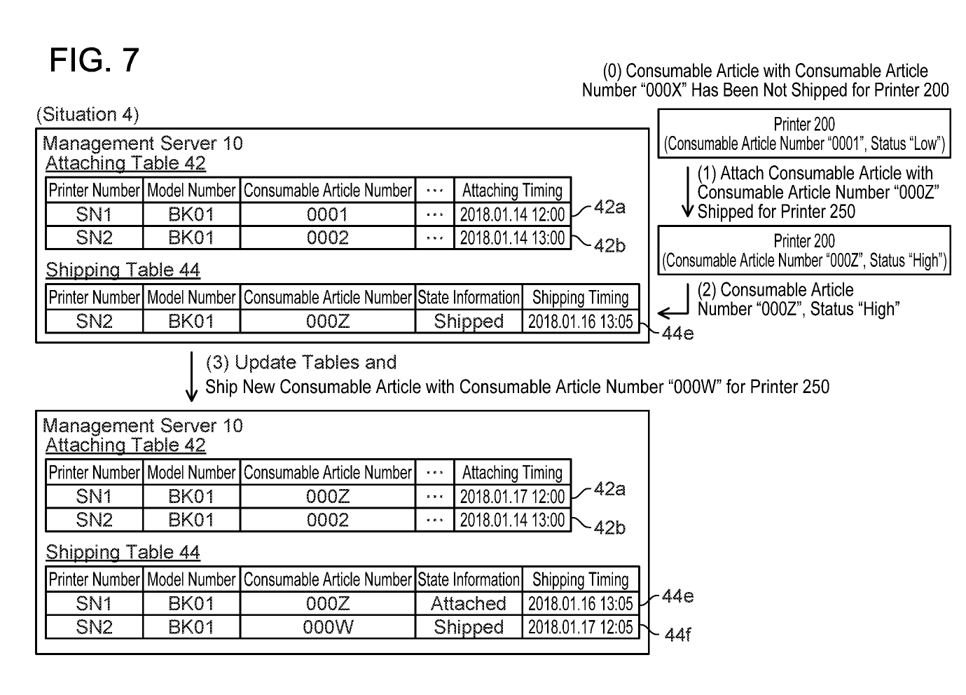

(Situation 4: FIG. 7)

Next, with reference to FIG. 7, the situation 4 in which a consumable article for the printer 250 is newly shipped due to a consumable article shipped for the printer 250 having been attached to the printer 200.

(0) The consumable article having the consumable article number “0001” is currently attached to the printer 200, and a consumable article having a consumable article number “0002” is currently attached to the printer 250. Therefore, the attaching table 42 in the management server 10 stores the attaching information 42a including the printer number SN1 and the consumable article number “0001”, and the attaching information 42b including the printer number SN2 and the consumable article number “0002”. In the situation 4, no consumable article for the printer 200 has been shipped to the user. Therefore, the shipping table 44 in the management server 10 does not store shipping information including the printer number SN1. Moreover, the situation 4 is a situation after the consumable article having the consumable article number “000Z” for the printer 250 has been shipped to the user. Therefore, the shipping table 44 in the management server 10 stores the shipping information 44e including the printer number SN2 and the consumable article number “000Z”.

(1) When the consumable article having the consumable article number “0001” is exhausted in the printer 200 before the shipping process for the printer 200 is executed, the consumable article having the consumable article number “000Z” shipped for the printer 250 is attached to the printer 200 in place of the consumable article having the consumable article number “0001”.

(2) In response to a predetermined time having elapsed, the printer 200 sends consumable article information including the consumable article number “000Z” and the status “High” to the management server 10.

(3) In response to receiving the consumable article information from the printer 200, the management server 10 updates the attaching table 42 and the shipping table 44. Specifically, the management server 10 stores the consumable article number “000Z” included in the consumable article information in place of the consumable article number “0001”, and updates the attaching timing to a current timing “2018.01.17 12:00”, in the attaching information 42a in the attaching table 42.

Moreover, the management server 10 specifies, from the shipping table 44, the shipping information 44e including the consumable article number “000Z” in the consumable article information, and specifies the shipping timing “2018.01.16 13:05” in the shipping information 44e. Moreover, the management server 10 specifies, from the attaching table 42, the attaching information 42b including the printer number SN2, and specifies the attaching timing “2018.01.14 13:00” in the attaching information 42b. The management server 10 then compares the specified attaching timing “2018.01.14 13:00” with the specified shipping timing “2018.01.16 13:05”. In this case, the specified attaching timing is before the specified shipping timing, and this means that no consumable article is newly attached to the printer 250 after the remaining amount of the consumable article having the consumable article number “0002” attached to the printer 250 has decreased. This also means that since the consumable article having the consumable article number “000Z” shipped for the printer 250 was attached to the printer 200, the user requires a consumable article for the printer 250. The management server 10 thus executes the shipping process for the printer 250 and newly stores shipping information 44f including the printer number SN2 and a consumable article number “000W” in the shipping table 44. Due to this, the user can attach the consumable article having the consumable article number “000W” to the printer 250 when the consumable article having the consumable article number “0002” is exhausted in the printer 250. Subsequently, the management server 10 stores the printer number SN1 in place of the printer number SN2 in the shipping information 44e, and changes the state information in the shipping information 44e from “Shipped” to “Attached”.

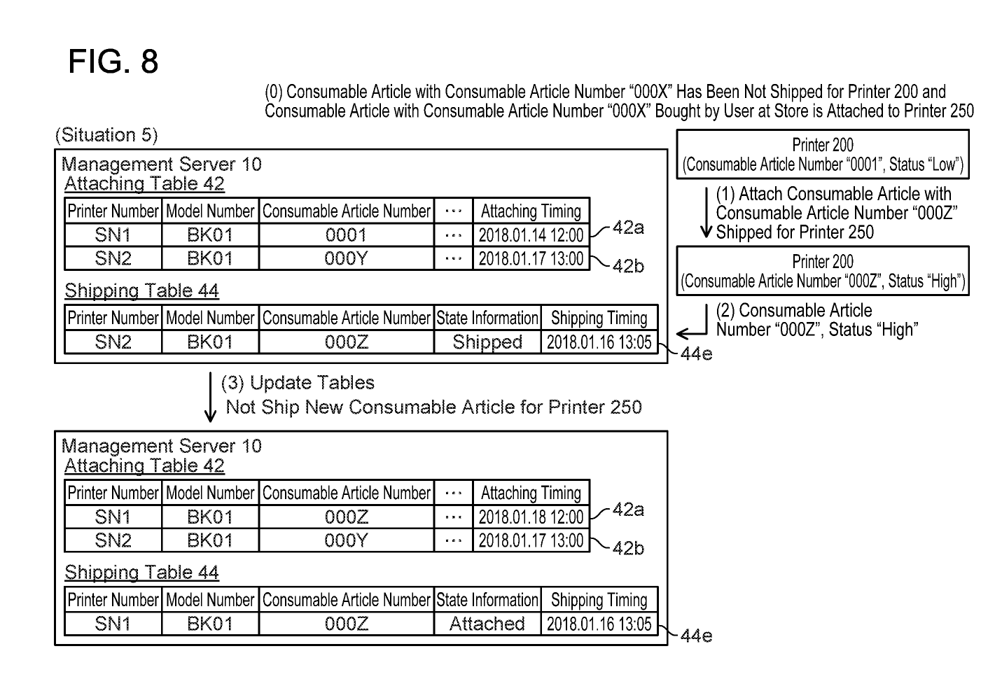

(Situation 5: FIG. 8)

Next, with reference to FIG. 8, the situation 5 in which a consumable article shipped for the printer 250 is not attached to the printer 250 will be described.

(0) In the situation 5, the consumable article having the consumable article number “000Y” bought at a store is attached to the printer 250 after the consumable article having the consumable article number “000Z” has been shipped for the printer 250 and before it is delivered to the user. The situation 5 is different from the situation 4 in FIG. 7 only in the above point. Therefore, the attaching table 42 in the management server 10 stores the attaching information 42a including the printer number SN1 and the consumable article number “0001” and the attaching information 42b including the printer number SN2 and the consumable article number “000Y”. Moreover, the shipping table 44 in the management server 10 does not store shipping information including the printer number SN1, and stores the shipping information 44e including the printer number SN2 and the consumable article number “000Z”.

(1) When the consumable article having the consumable article number “0001” is exhausted in the printer 200 before execution of the shipping process for the printer 200, the consumable article having the consumable article number “000Z” shipped for the printer 250 is attached to the printer 200 in place of the consumable article having the consumable article number “0001”.

(2) In response to a predetermined time having elapsed, the printer 200 sends consumable article information including the consumable article number “000Z” and the status “High” to the management server 10.

(3) In response to receiving the consumable article information from the printer 200, the management server 10 updates the attaching table 42 and the shipping table 44. Specifically, the management server 10 stores the consumable article number “000Z” included in the consumable article information in place of the consumable article number “0001”, and updates the attaching timing to a current timing “2018.01.18 12:00”, in the attaching information 42a in the attaching table 42.

Moreover, the management server 10 specifies, from the shipping table 44, the shipping information 44e including the consumable article number “000Z” in the consumable article information, and specifies the shipping timing “2018.01.16 13:05” in the shipping information 44e. Moreover, the management server 10 specifies, from the attaching table 42, the attaching information 42b including the printer number SN2, and specifies the attaching timing “2018.01.17 13:00” in the attaching information 42b. The management server 10 then compares the specified attaching timing “2018.01.17 13:00” with the specified shipping timing “2018.01.16 13:05”. In this case, the specified attaching timing is after the specified shipping timing, and this means that after the remaining amount of the consumable article attached to the printer 250 had decreased, a consumable article (i.e., the consumable article having the consumable article number “000Y”) was newly attached to the printer 250. This means that the user does not require a consumable article for the printer 250. Therefore, the management server 10 does not execute the shipping process for the printer 250. This can suppress a consumable article from being newly shipped to the user in the situation in which the user does not require another consumable article. Thus, this can suppress excess consumable articles from being owned by the user. Subsequently, the management server 10 stores the printer number SN1 in place of the printer number SN2 in the shipping information 44e, and changes the state information in the shipping information 44e from “Shipped” to “Attached”.

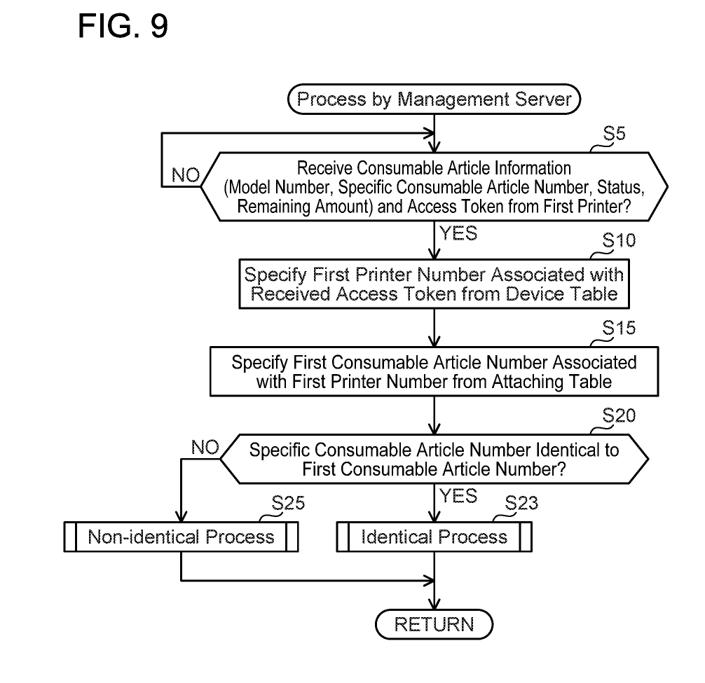

(Process by Management Server 10: FIG. 9)

Next, with reference to FIG. 9, a process executed by the management server 10 to implement the processes of FIGS. 3 to 8 above will be described. In S5, the management server 10 monitors reception of consumable article information and an access token (e.g., AT1) from a first printer (e.g., the printer 200) (e.g., T30, T40, and the like in FIG. 3). The consumable article information includes a model number, a consumable article number, a status, and a remaining amount of a consumable article. In a case where the consumable article information and the access token are received from the first printer, the management server 10 determines YES in S5, and proceeds to S10. The consumable article number included in the consumable article information received here will hereinafter be called a “specific consumable article number”.

In S10, the management server 10 specifies a first printer number (e.g., SN1) associated with the received access token, from the device table 40 (see FIG. 2).

In S15, the management server 10 specifies a first consumable article number associated with the specified first printer number, from the attaching table 42 (see FIG. 2).

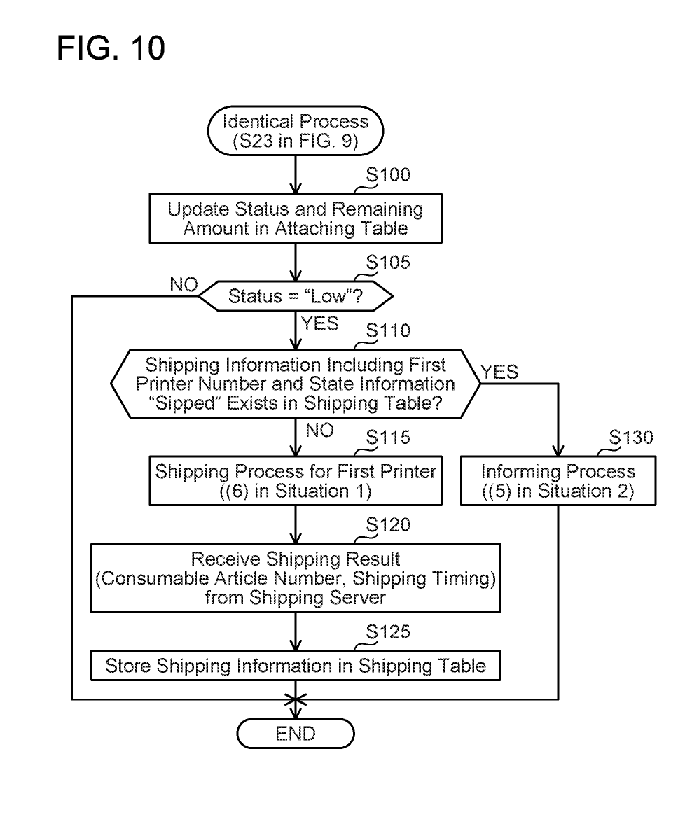

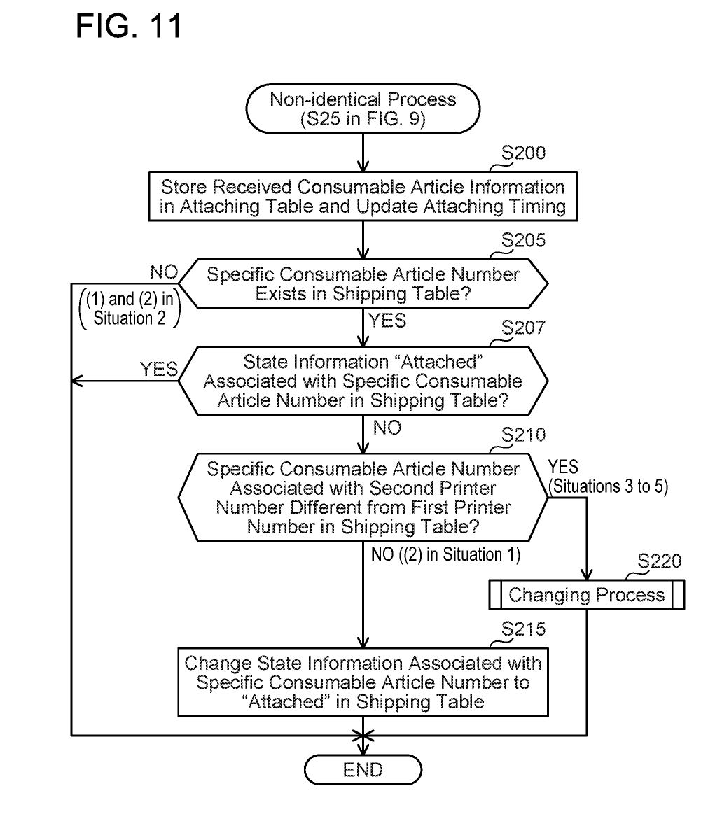

In S20, the management server 10 determines whether the specific consumable article number in the received consumable article information is identical to the first consumable article number. In a case of determining that the specific consumable article number is identical to the first consumable article number (e.g., (5) in the situation 1 in FIG. 4, (4) in the situation 2 in FIG. 5, and the like), the management server 10 determines YES in S20, and executes an identical process (see FIG. 10) in S23. On the other hand, in a case of determining that the specific consumable article number is not identical to the first consumable article number (e.g., (2) in the situation 1 in FIG. 4, (2) in the situation 2 in FIG. 5, and the like), the management server 10 executes a non-identical process (see FIG. 11) in S25. When completing the process of S23 or S25, the management server 10 returns to S5.

(Identical Process: FIG. 10)

Next, with reference to FIG. 10, the identical process executed in S23 in FIG. 9 will be described. In S100, the management server 10 specifies attaching information including the first consumable article number from the attaching table 42, and updates a status and a remaining amount in the specified attaching information to the status and the remaining amount in the consumable article information received in S5 in FIG. 9.

In S105, the management server 10 determines whether the status in the received consumable article information is “Low”. In a case where the status is “Low”, the management server 10 determines YES in S105, and proceeds to S110. On the other hand, in a case where the status is “High”, the management server 10 determines NO in S105, and terminates the process of FIG. 10. Due to this, execution of the shipping process for the first printer can be suppressed in a situation in which the status in the consumable article information is “High”, namely, in a situation where there is a low possibility that the consumable article attached to the first printer is exhausted. Therefore, an unused consumable article can be suppressed from being owned by a user for a long time.

In S110, the management server 10 determines whether shipping information including the first printer number (e.g., SN1) and the state information “Shipped” exists in the shipping table 44 (see FIG. 2). In a case of determining that the shipping information including the first printer number and the state information “Shipped” exists, the management server 10 determines YES in S110, and proceeds to S130. On the other hand, in a case of determining that the shipping information including the first printer number and the state information “Shipped” does not exist, the management server 10 determines NO in S110, and proceeds to S115.

In S130, the management server 10 executes the informing process of informing the user that a shipped consumable article is to be attached to the first printer ((5) in the situation 2 in FIG. 5). Specifically, the management server 10 specifies a first user name (e.g., U1) associated with the first printer number (e.g., SN1) from the device table 40, and specifies an e-mail address (e.g., MA1) associated with the first user name from the user table 38 (see FIG. 2). The management server 10 then sends, to the specified e-mail address, an electronic mail including a message indicating that the shipped consumable article is to be attached. In a variant, the management server 10 may send a predetermined notification to the first printer in S130 to cause the first printer to display the message indicating that the shipped consumable article is to be attached. When the informing process of S130 is executed, the user can know that the shipped consumable article is to be attached to the first printer.

In S115, the management server 10 executes the shipping process for the first printer. Specifically, the management server 10 firstly specifies the first user name (e.g., U1) associated with the first printer number from the device table 40, and specifies a first shipping address (e.g., A1) associated with the first user name from the user table 38 (see FIG. 2). The management server 10 then sends, to the shipping server 300, a shipping instruction including the model number in the consumable article information received in S5 in FIG. 9 and the specified first shipping address ((6) in the situation 1 in FIG. 4, T50 in FIG. 3). Consequently, the shipping server 300 ships a consumable article having the model number in the shipping instruction to the first shipping address in the shipping instruction (TM).

In S120, the management server 10 receives, from the shipping server 300, a shipping result including a consumable article number assigned to the shipped consumable article and a shipping timing that is a current timing (T52).

In S125, the management server 10 stores shipping information in the shipping table 44 ((6) in the situation 1 in FIG. 4, T53). This shipping information includes the first printer number, the model number in the consumable article information, the consumable article number in the shipping result, the state information “Shipped”, and the shipping timing in the shipping result (the shipping information 44d of (6) in the situation 1 in FIG. 4). When the process of S125 ends, the process of FIG. 10 ends.

(Non-Identical Process: FIG. 11)

Next, with reference to FIG. 11, the non-identical process executed in S25 in FIG. 9 will be described. In S200, the management server 10 specifies attaching information including the first printer number specified in S10 in FIG. 9 from the attaching table 42, and stores the consumable article information received in S5 in place of the consumable article information in that attaching information ((3) in the situation 1 in FIG. 4, (3) in the situation 2 in FIG. 5).

In S205, the management server 10 determines whether the specific consumable article number is stored in the shipping table 44. In a case where the specific consumable article number is stored in the shipping table 44, namely, in a case where a consumable article having the specific consumable article number is a shipped consumable article, the management server 10 determines YES in S205, and proceeds to S207. On the other hand, in a case where the specific consumable article number is not stored in the shipping table 44, namely, in a case where the consumable article having the specific consumable article number is not a shipped consumable article ((1) and (2) in the situation 2 in FIG. 5), the management server 10 determines NO in S205, and terminates the process of FIG. 11. In other words, the management server 10 does not execute the shipping process in this case ((3) in the situation 2).

In S207, the management server 10 determines whether the attaching information associated with the specific consumable article number in the shipping table 44 is “Attached”. In a case where the attaching information associated with the specific consumable article number is “Attached”, the management server 10 determines YES in S207, and terminates the process of FIG. 11. On the other hand, in a case where the attaching information associated with the specific consumable article number is “Shipped”, the management server 10 determines NO in S207, and proceeds to S210.

Here, the situation in which the attaching information associated with the specific consumable article number is “Attached”, namely, the situation in which the management server 10 determines YES in S207 is a situation as follows, for example. In other words, a situation is assumed in which after (3) in the situation 3 in FIG. 6, the consumable article having the consumable article number “000Z” is detached from the printer 200 and then is attached to the printer 250. In this case, the management server 10 receives, from the printer 250, consumable article information including the consumable article number “000Z” in the situation in which the attaching information associated with the consumable article number “000Z” in the shipping table 44 is “Attached”. When this happens, the management server 10 determines YES in S207, and do not execute S210 to S220.

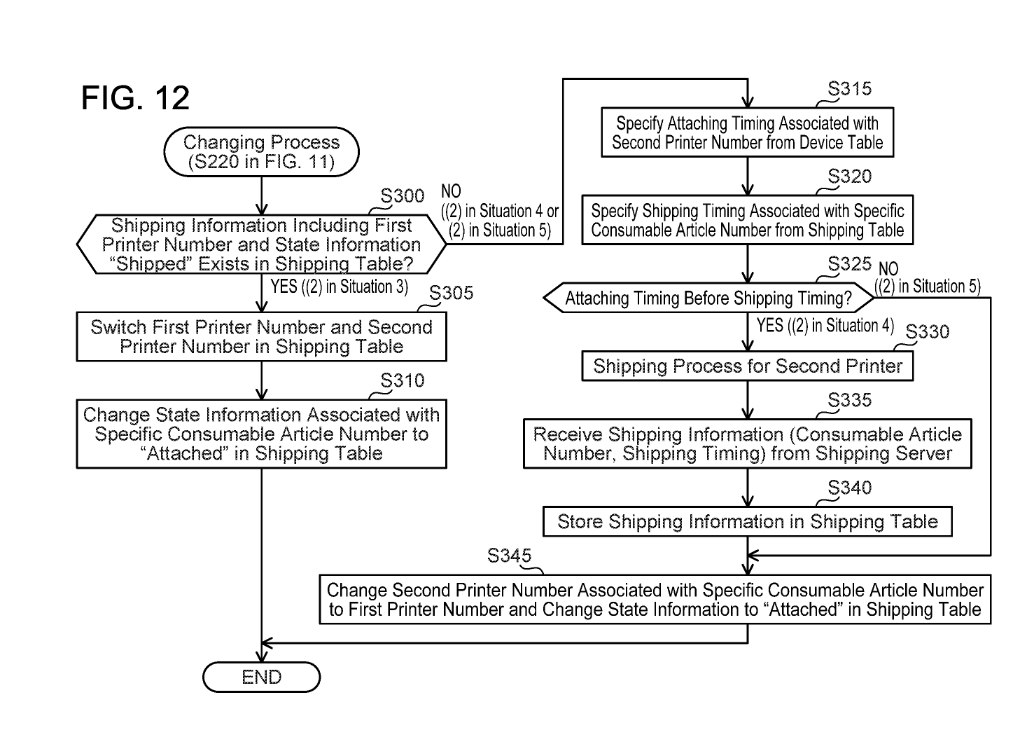

In S210, the management server 10 determines whether a second printer number (e.g., SN2) different from the first printer number is associated with the specific consumable article number in the shipping table 44. In a case of determining that the second printer number and the specific consumable article number are associated with each other, namely, in a case where the consumable article currently attached to the first printer is a consumable article shipped for the second printer (the situations 3 to 5 in FIGS. 6 to 8), the management server 10 executes a changing process (see FIG. 12) in S220, and terminates the process of FIG. 11. On the other hand, in a case of determining that the second printer number and the specific consumable article number are not associated with each other (i.e., in a case of determining that the first printer number and the specific consumable article number are associated with each other), namely, in a case where the consumable article currently attached to the first printer is a consumable article shipped for the first printer ((2) in the situation 1 in FIG. 4), the management server 10 proceeds to S215.

In S215, the management server 10 changes the state information associated with the specific consumable article number in the shipping table 44 from “Shipped” to “Attached” (e.g., (3) in the situation 1 in FIG. 4). When the process of S215 ends, the process of FIG. 11 ends.

(Changing Process: FIG. 12)

Next, with reference to FIG. 12, the changing process executed in S220 in FIG. 11 will be described. In S300, the management server 10 determines whether shipping information including the first printer number and the state information “Shipped” exists in the shipping table 44. In a case where the shipping information including the first printer number and the state information “Shipped” exists ((2) in the situation 3 in FIG. 6), the management server 10 determines YES in S300, and proceeds to S305.

In S305, the management server 10 switches the first printer number and the second printer number in the shipping table 44 ((3) in the situation 3 in FIG. 6). Specifically, the management server 10 stores the first printer number, in place of the second printer number, in the shipping information including the second printer number and the specific consumable article number, and stores the second printer number, in place of the first printer number, in the shipping information specified in S300 (i.e., the shipping information including the first printer number and the state information “Shipped”).

In S310, the management server 10 changes the state information associated with the specific consumable article number in the shipping table 44 from “Shipped” to “Attached” (the shipping information 44e in (3) in the situation 3 in FIG. 6). When the process of S310 ends, the process of FIG. 12 ends.

On the other hand, in a case where the shipping information including the first printer number and the state information “Shipped” does not exist in the shipping table 44 ((2) in the situation 4 in FIG. 7, (2) in the situation 5 in FIG. 8), the management server 10 determines NO in S300, and proceeds to S315.

In S315, the management server 10 specifies an attaching timing associated with the second printer number (see S210 in FIG. 11) from the device table 40.

In S320, the management server 10 specifies a shipping timing associated with the specific consumable article number from the shipping table 44.

In S325, the management server 10 determines whether the specified attaching timing is before the specified shipping timing. In a case of determining that the attaching timing is before the shipping timing ((2) in the situation 4 in FIG. 7), the management server 10 determines YES in S325, and proceeds to S330. On the other hand, in a case where of determining that the attaching timing is after the shipping timing ((2) in the situation 5 in FIG. 8), the management server 10 determines NO in S325, skips processes of S330 to S340, and proceeds to S345. In this case, the management server 10 does not execute the shipping process for the second printer ((3) in the situation 5 in FIG. 8).

In S330, the management server 10 executes the shipping process for the second printer having the second printer number. Specifically, the management server 10 firstly specifies a second user name associated with the second printer number from the device table 40, and specifies a second shipping address associated with the second user name from the user table 38. The management server 10 then sends, to the shipping server 300, a shipping instruction including the model number in the consumable article information received in S5 and the specified second shipping address ((3) in the situation 4 in FIG. 7). Consequently, the shipping server 300 ships a consumable article having the model number in the shipping instruction to the second shipping address in the shipping instruction. S335 and S340 are similar to S120 and S125 in FIG. 10.

In S345, the management server 10 specifies shipping information including the specific consumable article number from the shipping table 44, changes the second printer number in that shipping information to the first printer number, and changes the state information in that shipping information from “Shipped” to “Attached” (the shipping information 44e in (3) in the situation 4 in FIG. 7, and the shipping information 44e in (3) in the situation 5 in FIG. 8). When the process of S345 ends, the process of FIG. 12 ends.

### Effects of Present Embodiment

In the present embodiment, in a case of executing the shipping process for shipping a consumable article to be attached to the first printer (S115 in FIG. 10), the management server 10 stores the shipping information including the first printer number, the model number, the first consumable article number, the state information “Shipped”, and the shipping timing in the shipping table 44 (S125). The management server 10 then receives the consumable article information including the specific consumable article number from the first printer. In a case of determining that the first consumable article number is identical to the specific consumable article number (YES in S20 in FIG. 9), namely, in a case where the shipped consumable article is appropriately attached to the first printer, the management server 10 executes the shipping process for shipping a new consumable article to be attached to the first printer (S115). On the other hand, in a case of determining that the first consumable article number is not identical to the specific consumable article number (NO in S20), namely, in a case where a consumable article different from the shipped consumable article is attached to the first printer, the management server 10 does not execute the shipping process (NO in S205 in FIG. 11). This can suppress execution of the shipping process in a situation in which an unused consumable article is owned by a user of the first printer. Consequently, excess consumable articles can be suppressed from being owned by the user. In the present embodiment, “excess consumable articles being owned by a user” means that a user that owns N printers (N is an integer equal to or greater than one) (e.g., 200, 250) owns (N+1) or more unused consumable articles.

(Correspondence Relationships)

The management server 10, the printer 200, the printer 250, and the shipping server 300 are examples of “control device”, “first device”, “second device”, and “server”, respectively. The first printer number, the second printer number, the first consumable article number, the specific consumable article number are examples of “first device identification information”, “second device identification information”, “first code”, and “specific code”, respectively. The attaching timing and the shipping timing are examples of “attaching timing information” and “shipping timing information”, respectively. The status is an example of “remaining amount information”.

The processes of S115 in FIG. 10 and of S330 in FIG. 12 are examples of a process executed by “execute a shipping process”. The processes of S125 and S340 are examples of a process executed by “store in a memory an association of device identification information for identifying the device and a code assigned to the consumable article”. The process of S20 in FIG. 9 is an example of a process executed by “determine whether the specific code is identical to the first code”.

The processes of S205 and S210 in FIG. 11 are examples of processes executed by “determine whether the specific code is associated with device identification information” of claim 2 and “determine whether the specific code is associated device identification information” of claim 3. The processes of S315 and S320 are examples of a process executed by “specify the attaching timing information and the shipping timing information”. The process of S305 in FIG. 12, the process of S 200, the process of S325, the process of S130, the process of S105, and the process of S120 are examples of processes executed by “change a state in which the first device identification information is associated with the first code and the second device identification information is associated with the specific code to a state in which the second device identification information is associated with the first code”, “store an association of the second device identification information, the second code, and attaching timing information”, “determine whether the date and time indicated by the specified attaching timing information is before the date and time indicated by the specified shipping timing information”, “inform a user of the first device that the first consumable article that was already shipped is to be attached to the first device”, “determine whether the remaining amount of the specific consumable article is less than a threshold value”, and “receive from the server a code assigned to a consumable article of a shipping target”, respectively.

(Variant 1)

The shipping process may be executed by a device (e.g., a management PC) different from the management server 10. In this case, in T40 in FIG. 3, the printer 200 sends the consumable article information and the access token AT1 to the management PC. In response to receiving the consumable article information and the access token AT1 from the printer 200, the management PC determines that the status in the consumable article information is “Low”, and sends a shipping address request including the consumable article information and the access token AT1 to the management server 10. In response to receiving the shipping address request from the management PC, the management server 10 specifies the shipping address A1 by using the access token AT1 in the shipping address request, and sends the shipping address A1 to the management PC. In response to receiving the shipping address A1 from the management server 10, the management PC sends to the shipping server 300 a shipping instruction including the shipping address A1 and the model number “BK01” in the consumable article information. Consequently, the shipping server 300 ships a consumable article having the model number “BK01” in the shipping instruction to the shipping address A1 in the shipping instruction. In the present variant, a combination of the management server 10 and the management PC is an example of “control device”.

(Variant 2)

The non-identical process in S25 in FIG. 9 may be omitted. In this case, in a case of determining NO in S20, the management server 10 terminates the process of FIG. 9. In the present variant, “determine whether the specific code is associated with device identification information” of claim 2, “change a state in which the first device identification information is associated with the first code and the second device identification information is associated with the specific code to a state in which the second device identification information is associated with the first code”, “determine whether the specific code is associated with device identification information” of claim 3, “specify the attaching timing information and the shipping timing information”, and “determine whether the date and time indicated by the specified attaching timing information is before the date and time indicated by the specified shipping timing information” can be omitted.

(Variant 3)

The process of S130 in FIG. 10 may be omitted. In this case, in the case of determining NO in S110, the management server 10 terminates the process of FIG. 10. In the present variant, “inform a user of the first device that the first consumable article that was already shipped is to be attached to the first device” can be omitted.

(Variant 4)

The process of S105 in FIG. 10 may be omitted. In this case, each of the printers 200, 250 may adopt a configuration that sends the consumable article information to the management server 10 only in a case where the status is changed to “Low”. In the present variant, “determine whether the remaining amount of the specific consumable article is less than a threshold value” can be omitted.

(Variant 5)

The management server 10 may execute the process executed by the shipping server 300. In this case, the management server 10, for example, omits the process of T50 in FIG. 3, ships a consumable article having the model number “BK01” to the shipping address A1, and stores the shipping information 44c in the shipping table 44. In the present variant, “receive from the server a code assigned to a consumable article of a shipping target” can be omitted.

(Variant 6)

The attaching table 42 may store information that indicates a used amount of a consumable article, in place of the remaining amount. In this case, each of the printers 200, 250 sends consumable article information including the used amount, in place of the remaining amount, to the management server 10.

(Variant 7)

“Device” is not limited to a printer, and includes any device to which a consumable article is attached, such as a multifunction device, a sewing machine, and the like.

(Variant 8)

In the above embodiment, each of the processes in FIGS. 3 to 12 is implemented by software (i.e., the program 36), however, at least one of the processes may be implemented by hardware such as a logic circuit and the like.

What is claimed is:

1. A control device comprising:
a processor; and
a memory storing computer-readable instructions therein, the computer-readable instructions, when executed by the processor, causing the control device to:
execute a shipping process for shipping a consumable article to be attached to a device;
every time the shipping process for shipping a consumable article to be attached to a device is executed, store in a memory an association of device identification information for identifying the device and a code assigned to the consumable article; and
in a case where a specific code assigned to a specific consumable article is received from a first device after an association of first device identification information for identifying the first device and a first code assigned to a first consumable article has been stored in the memory due to execution of a first shipping process which is the shipping process for shipping the first consumable article to be attached to the first device and after the specific consumable article has been newly attached to the first device, determine whether the specific code is identical to the first code associated with the first device identification information in the memory,
wherein in a case where it is determined that the specific code is identical to the first code, a second shipping process which is the shipping process for shipping a second consumable article to be attached to the first device is executed, and
in a case where it is determined that the specific code is not identical to the first code, the second shipping process is not executed.

2. The control device as in claim 1, wherein
the computer-readable instructions, when executed by the processor, further causing the control device to:
in the case where the specific code is received from the first device after the association of the first device identification information and the first code has been stored in the memory due to the execution of the first shipping process, determine whether the specific code is associated with device identification information different from the first device identification information in the memory; and
in a case where it is determined that the specific code is not identical to the first code and it is determined that the specific code is associated with second device identification information different from the first device identification information, change a state in which the first device identification information is associated with the first code and the second device identification information is associated with the specific code to a state in which the second device identification information is associated with the first code.

3. The control device as in claim 1, wherein
the computer-readable instructions, when executed by the processor, further causing the control device to:
in a case where the specific code is received from the first device before the first shipping process is executed, determine whether the specific code is associated with device identification information different from the first device identification information in the memory,
wherein in a case where the specific code is received from the first device before the first shipping process is executed and it is determined that the specific code is associated with second device identification information different from the first device identification information, a third shipping process which is the shipping process for shipping a third consumable article to be attached to a second device identified by the second device identification information is executed.

4. The control device as in claim 3, wherein
in a case where a specific shipping process which is the shipping process for shipping the specific consumable article to be attached to the second device is executed, an association of the second device identification information, the specific code, and shipping timing information is stored in the memory, the shipping timing information being related to date and time when the specific shipping process was executed,
the computer-readable instructions, when executed by the processor, further causing the control device to:
in a case where a second code assigned to a fourth consumable article is received from the second device after the fourth consumable article has been newly attached to the second device, store an association of the second device identification information, the second code, and attaching timing information in the memory, the attaching timing information being related to date and time when the fourth consumable article was attached;
in a case where the specific code is received from the first device before the first shipping process is executed and it is determined that the specific code is associated with the second device identification information, specify the attaching timing information associated with the second device identification information in the memory and the shipping timing information associated with the second device identification information in the memory; and
determine whether the date and time indicated by the specified attaching timing information is before the date and time indicated by the specified shipping timing information,
wherein in a case where it is determined that the date and time indicated by the attaching timing information is before the date and time indicated by the shipping timing information, the third shipping process is executed, and
in a case where it is determined that the date and time indicated by the attaching timing information is after the date and time indicated by the shipping timing information, the third shipping process is not executed.

5. The control device as in claim 1, wherein
in a case where the specific code is received from the first device again after it has been determined that the specific code is not identical to the first code, the second shipping process is not executed, and
the computer-readable instructions, when executed by the processor, further causing the control device to:
in the case where the specific code is received from the first device again, inform a user of the first device that the first consumable article that was already shipped is to be attached to the first device.

6. The control device as in claim 1, wherein
the computer-readable instructions, when executed by the processor, further causing the control device to:
in a case where the specific code and remaining amount information related to a remaining amount of the specific consumable article are received from the first device, determine whether the remaining amount of the specific consumable article is less than a threshold value by using the remaining amount information,
wherein in a case where it is determined that the specific code is identical to the first code and the remaining amount indicated by the remaining amount information is less than the threshold value, the second shipping process is executed, and
in a case where it is determined that the remaining amount indicated by the remaining amount information is equal to or greater than the threshold value, the second shipping process is not executed.

7. The control device as in claim 1, wherein
the shipping process includes sending a shipping instruction of a consumable article to a server different from the control device, and
the computer-readable instructions, when executed by the processor, further causing the control device to:
every time the shipping instruction is sent to the server, receive from the server a code assigned to a consumable article of a shipping target,
wherein every time the shipping process for shipping a consumable article to be attached to a device is executed, an association of device identification information for identifying the device and a code that is assigned to the consumable article and received from the server is stored in the memory.

8. The control device as in claim 1, wherein
the code is article identification information for identifying the consumable article.

9. A non-transitory computer-readable recording medium storing computer-readable instructions for a control device,
wherein the computer-readable instructions, when executed by a processor of the control device, causing the control device to:
execute a shipping process for shipping a consumable article to be attached to a device;
every time the shipping process for shipping a consumable article to be attached to a device is executed, store in a memory an association of device identification information for identifying the device and a code assigned to the consumable article; and
in a case where a specific code assigned to a specific consumable article is received from a first device after an association of first device identification information for identifying the first device and a first code assigned to a first consumable article has been stored in the memory due to execution of a first shipping process which is the shipping process for shipping the first consumable article to be attached to the first device and after the specific consumable article has been newly attached to the first device, determine whether the specific code is identical to the first code associated with the first device identification information in the memory,
wherein in a case where it is determined that the specific code is identical to the first code, a second shipping process which is the shipping process for shipping a second consumable article to be attached to the first device is executed, and
in a case where it is determined that the specific code is not identical to the first code, the second shipping process is not executed.

10. The non-transitory computer-readable recording medium as in claim 9, wherein the computer-readable instructions, when executed by the processor, further causing the control device to:
in the case where the specific code is received from the first device after the association of the first device identification information and the first code has been stored in the memory due to the execution of the first shipping process, determine whether the specific code is associated with device identification information different from the first device identification information in the memory; and
in a case where it is determined that the specific code is not identical to the first code and it is determined that the specific code is associated with second device identification information different from the first device identification information, change a state in which the first device identification information is associated with the first code and the second device identification information is associated with the specific code to a state in which the second device identification information is associated with the first code.

11. The non-transitory computer-readable recording medium as in claim 9, wherein the computer-readable instructions, when executed by the processor, further causing the control device to:
in a case where the specific code is received from the first device before the first shipping process is executed, determine whether the specific code is associated with device identification information different from the first device identification information in the memory,
wherein in a case where the specific code is received from the first device before the first shipping process is executed and it is determined that the specific code is associated with second device identification information different from the first device identification information, a third shipping process which is the shipping process for shipping a third consumable article to be attached to a second device identified by the second device identification information is executed.

12. The non-transitory computer-readable recording medium as in claim 11, wherein
in a case where a specific shipping process which is the shipping process for shipping the specific consumable article to be attached to the second device is executed, an association of the second device identification information, the specific code, and shipping timing information is stored in the memory, the shipping timing information being related to date and time when the specific shipping process was executed,
the computer-readable instructions, when executed by the processor, further causing the control device to:
in a case where a second code assigned to a fourth consumable article is received from the second device after the fourth consumable article has been newly attached to the second device, store an association of the second device identification information, the second code, and attaching timing information in the memory, the attaching timing information being related to date and time when the fourth consumable article was attached;
in a case where the specific code is received from the first device before the first shipping process is executed and it is determined that the specific code is associated with the second device identification information, specify the attaching timing information associated with the second device identification information in the memory and the shipping timing information associated with the second device identification information in the memory; and
determine whether the date and time indicated by the specified attaching timing information is before the date and time indicated by the specified shipping timing information,
wherein in a case where it is determined that the date and time indicated by the attaching timing information is before the date and time indicated by the shipping timing information, the third shipping process is executed, and
in a case where it is determined that the date and time indicated by the attaching timing information is after the date and time indicated by the shipping timing information, the third shipping process is not executed.

13. The non-transitory computer-readable recording medium as in claim 9, wherein
in a case where the specific code is received from the first device again after it has been determined that the specific code is not identical to the first code, the second shipping process is not executed, and
the computer-readable instructions, when executed by the processor, further causing the control device to:
in the case where the specific code is received from the first device again, inform a user of the first device that the first consumable article that was already shipped is to be attached to the first device.

14. The non-transitory computer-readable recording medium as in claim 9, wherein
the computer-readable instructions, when executed by the processor, further causing the control device to:
in a case where the specific code and remaining amount information related to a remaining amount of the specific consumable article are received from the first device, determine whether the remaining amount of the specific consumable article is less than a threshold value by using the remaining amount information,
wherein in a case where it is determined that the specific code is identical to the first code and the remaining amount indicated by the remaining amount information is less than the threshold value, the second shipping process is executed, and
in a case where it is determined that the remaining amount indicated by the remaining amount information is equal to or greater than the threshold value, the second shipping process is not executed.

15. The non-transitory computer-readable recording medium as in claim 9, wherein
the shipping process includes sending a shipping instruction of a consumable article to a server different from the control device, and
the computer-readable instructions, when executed by the processor, further causing the control device to:
every time the shipping instruction is sent to the server, receive from the server a code assigned to a consumable article of a shipping target,
wherein every time the shipping process for shipping a consumable article to be attached to a device is executed, an association of device identification information for identifying the device and a code that is assigned to the consumable article and received from the server is stored in the memory.

16. The non-transitory computer-readable recording medium as in claim 9, wherein
the code is article identification information for identifying the consumable article.

17. A method comprises:
executing a shipping process for shipping a consumable article to be attached to a device;
every time the shipping process for shipping a consumable article to be attached to a device is executed, storing in a memory an association of device identification information for identifying the device and a code assigned to the consumable article; and
in a case where a specific code assigned to a specific consumable article is received from a first device after an association of first device identification information for identifying the first device and a first code assigned to a first consumable article has been stored in the memory due to execution of a first shipping process which is the shipping process for shipping the first consumable article to be attached to the first device and after the specific consumable article has been newly attached to the first device, determining whether the specific code is identical to the first code associated with the first device identification information in the memory,
wherein in a case where it is determined that the specific code is identical to the first code, a second shipping process which is the shipping process for shipping a second consumable article to be attached to the first device is executed, and
in a case where it is determined that the specific code is not identical to the first code, the second shipping process is not executed.

18. The method as in claim 17, further comprising:
in the case where the specific code is received from the first device after the association of the first device identification information and the first code has been stored in the memory due to the execution of the first shipping process, determining whether the specific code is associated with device identification information different from the first device identification information in the memory; and
in a case where it is determined that the specific code is not identical to the first code and it is determined that the specific code is associated with second device identification information different from the first device identification information, changing a state in which the first device identification information is associated with the first code and the second device identification information is associated with the specific code to a state in which the second device identification information is associated with the first code.

19. The method as in claim 17, further comprising:
in a case where the specific code is received from the first device before the first shipping process is executed, determining whether the specific code is associated with device identification information different from the first device identification information in the memory,
wherein in a case where the specific code is received from the first device before the first shipping process is executed and it is determined that the specific code is associated with second device identification information different from the first device identification information, a third shipping process which is the shipping process for shipping a third consumable article to be attached to a second device identified by the second device identification information is executed.

20. The method as in claim 19, wherein
in a case where a specific shipping process which is the shipping process for shipping the specific consumable article to be attached to the second device is executed, an association of the second device identification information, the specific code, and shipping timing information is stored in the memory, the shipping timing information being related to date and time when the specific shipping process was executed,
the method further comprises:
in a case where a second code assigned to a fourth consumable article is received from the second device after the fourth consumable article has been newly attached to the second device, storing an association of the second device identification information, the second code, and attaching timing information in the memory, the attaching timing information being related to date and time when the fourth consumable article was attached;
in a case where the specific code is received from the first device before the first shipping process is executed and it is determined that the specific code is associated with the second device identification information, specifying the attaching timing information associated with the second device identification information in the memory and the shipping timing information associated with the second device identification information in the memory; and
determining whether the date and time indicated by the specified attaching timing information is before the date and time indicated by the specified shipping timing information,
wherein in a case where it is determined that the date and time indicated by the attaching timing information is before the date and time indicated by the shipping timing information, the third shipping process is executed, and
in a case where it is determined that the date and time indicated by the attaching timing information is after the date and time indicated by the shipping timing information, the third shipping process is not executed.
